(19) United States
(12) Patent Application Publication
(10) Pub. No.: US 2023/0028827 A1
(43) Pub. Date: Jan. 26, 2023

(54) MANUFACTURING METHOD OF CARBON FIBER RACKETS

(71) Applicant: Wen-Ming HSU, Taichung City (TW)

(72) Inventor: Wen-Ming HSU, Taichung City (TW)

(21) Appl. No.: 17/383,730

(22) Filed: Jul. 23, 2021

(51) Int. Cl. B29C 70/44; A63B 49/11

(52) U.S. Cl. CPC B29C 70/446; A63B 49/11; B29L 2031/5245

(57) ABSTRACT

A manufacturing method of carbon fiber rackets includes the steps of preparing a core material and setting a blowing bag on the core material, wrapping multiple prepreg layers of carbon fiber materials on the outside of the blowing bag to become a sample to be molded, taking out the core material and placing the sample to be molded into a mold, closing the mold and heating and pressurizing the mold, and inflating the blowing bag to harden the multiple prepreg layers, expelling the air in the blowing bag to reduce the volume of the blowing bag, and opening the mold and drawing out the blowing bag and then taking out the hardened racket frame rough embryo thus obtained.

### BACKGROUND OF THE INVENTION

### 1. Field of the Invention

The present invention relates to the manufacture of composite material rackets, in particular to a manufacturing method of carbon fiber rackets.

### 2. Description of the Related Art

At present, most rackets on the market are made of composite materials such as carbon fiber. For example, the U.S. Pat. No. 4,294,787 “method of producing reinforced composite racket frame” disclosed that embedding a forming material in a thermosetting material layer, and then putting the thermosetting material layer with the forming material into a mold cavity, and then introducing a pressurized gas into the mold cavity and heating and pressing the mold to make the foaming material expand and fill the thermosetting material layer. Although this method can make the racket frame with composite materials, there will still be foam materials in the racket frame as the core support, which will not only increase the weight of the racket but also affect the elasticity of the racket.

### SUMMARY OF THE INVENTION

The present invention has been accomplished under the circumstances in view. It is the main object of the present invention to provide a manufacturing method of carbon fiber rackets, so that the racket made can be hollow to reduce its weight and increase its elasticity.

To achieve this and other objects of the present invention, a manufacturing method of carbon fiber rackets comprises the steps of: preparing a core material and setting a blowing bag on the core material jacket, which blowing bag has an inflatable hole at one end thereof; rolling multiple prepreg layers of carbon fiber materials on the outside of the blowing bag, so that the prepreg layers of carbon fiber materials are wrapped on the outside of the blowing bag to form a shape to be molded; taking out the core material and placing the sample to be molded into a mold; closing the mold and heating and pressurizing the mold, and inflating the blowing bag; expelling the air in the blowing bag to reduce the volume of the blowing bag so that the blowing bag is separable from the hardened prepreg layer; and opening the mold and drawing out the blowing bag and then taking out the hardened racket frame rough embryo thus obtained.

With the above structure, the manufacturing method of carbon fiber rackets of the present invention can use inflation of the blowing bag to expand it in the mold, forcing the prepreg layers covering the outer surface of the blowing bag to be sandwiched between the blowing bag and the inner walls of the cavity of the mold. Coupled with heating the mold, the prepreg layers can be cured and formed into a hollow, lightweight and flexible racket frame.

Preferably, the inflation pressure of the blowing bag is about 5.5˜6.5 kg/cm2.

Preferably, the mold is heated to 120° C.˜140° C., and the heating time to heat the mold is about 20 to 30 minutes.

Preferably, the mold is heated to 135° C.

### BRIEF DESCRIPTION OF THE DRAWINGS

FIG. 1 is a schematic diagram of the present invention to be formed in a mold.

FIG. 2 is a sectional view of the racket of FIG. 1.

### DETAILED DESCRIPTION OF THE INVENTION

The applicant first explains here that throughout the specification, including the embodiments described below and the claims in the scope of the patent application, the nouns related to directionality are based on the directions in the drawings. Secondly, in the preferred embodiment and drawings that will be introduced below, the same element numbers represent the same or similar elements or their structural features.

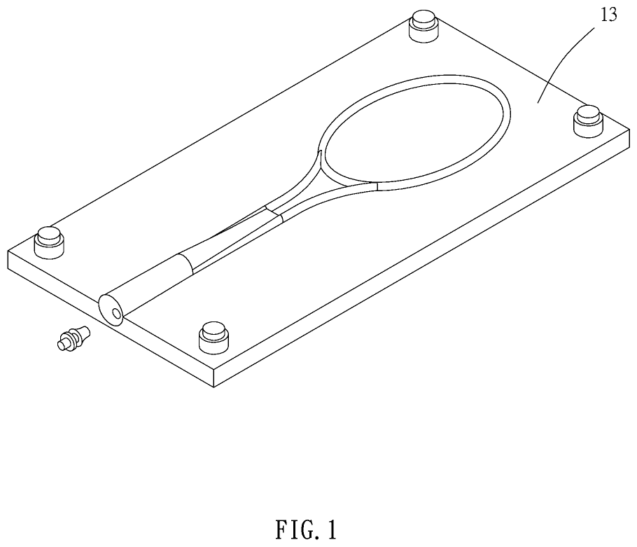

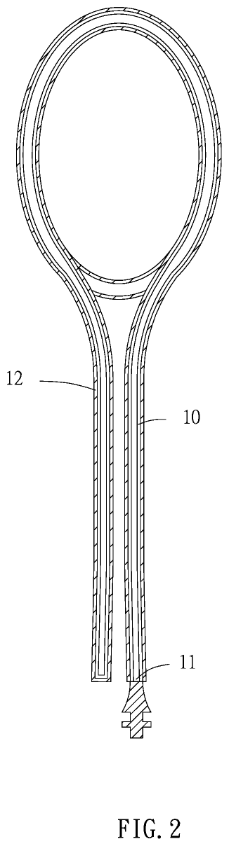

Please refer to FIGS. 1 and 2, the manufacturing method of carbon fiber rackets of the present invention includes the steps of:

1. Prepare a core material, and set a blowing bag 10 outside the core material. The blowing bag is made of nylon or cellophane and other high-temperature resistant materials, and its heat-resistant temperature range is about 110° C.˜150° C. One end of the blowing bag is airtight and the other end is provided with an inflatable hole 11. Basically, the shape of the blowing bag is similar to a long balloon.

2. Roll a multilayer carbon fiber material prepreg layer 12 on the outside of the blowing bag, so that the carbon fiber material prepreg layer is wrapped on the outside of the blowing bag to become a shape to be molded.

3. Take out the core material and place the sample to be molded in a mold 13 so that the end of the inflatable hole of the blowing bag is exposed to the mold.

4. Close the mold and then heat and pressurize the mold and inflate the blowing bag. The air pressure of inflation is about 5.5˜6.5 kg/cm2, and the mold is heated to 130° C. The heating temperature and time will be adjusted according to the number of prepreg layers and the temperature of the environment, generally around 120° C.˜140° C. The blowing bag 10 will expand its volume due to inflation and expand outwards, forcing the prepreg layers wrapped on the outside to closely adhere to the inner wall of the mold cavity. The heating time of the mold is about 20 to 30 minutes to harden the prepreg layer to form a racket frame.

5. Deflate, exhaust the air in the blowing bag, reduce the volume of the blowing bag, and make the blowing bag separate from the hardened prepreg layer.

6. Open the mold, draw out the deflated blowing bag and take out the hardened racket frame rough embryo, place the racket frame rough embryo to cool to room temperature to make the shape fixed.

According to the above-mentioned manufacturing method of carbon fiber rackets of the present invention, the core material used at the beginning of the racket is only conducive to the wrapping of the prepreg layer, and it is pulled away after the wrapping, so it does not exist in the finished product. And the blowing bag is only one of the fixtures in the processing process. Inflate the blowing bag to expand it in the mold, forcing the prepreg layer covering the outer surface of the blowing bag to be sandwiched between the blowing bag and the inner wall of the mold cavity. Coupled with heating the mold, the prepreg layer can be cured and formed.

Thereby, the racket frame made by the method of the present invention will be in a hollow state, as shown in FIG. 2. In this way, the weight of the racket can be reduced due to the lack of internal foam material after molding, and because of the hollow structure, the racket will be more elastic, and the amount of deformation can also be better than the previous products, which can provide users with better playing performance, so as to improve the shortcomings of the prior art racket manufacturing methods.

What is claimed is:

1. A manufacturing method of carbon fiber rackets, comprising the steps of:
a) preparing a core material, and setting a blowing bag on said core material jacket, said blowing bag having an inflatable hole at one end thereof;
b) rolling multiple prepreg layers of carbon fiber materials on the outside of said blowing bag, so that said prepreg layers of carbon fiber materials are wrapped on the outside of said blowing bag to form a shape to be molded;
c) taking out said core material and placing the sample of said prepreg layers of carbon fiber materials and said blowing bag to be molded into a mold;
d) closing said mold and heating and pressurizing said mold, and inflating said blowing bag;
e) expelling the air in said blowing bag to reduce the volume of said blowing bag so that said blowing bag is separable from said hardened prepreg layer; and
f) opening said mold and drawing out said blowing bag and then taking out the hardened racket frame rough embryo thus obtained.

2. The manufacturing method of carbon fiber rackets as claimed in claim 1, wherein the inflation pressure of said blowing bag is about 5.5˜6.5 kg/cm2.

3. The manufacturing method of carbon fiber rackets as claimed in claim 2, wherein said mold is heated to 120° C.˜140° C.

4. The manufacturing method of carbon fiber rackets as claimed in claim 3, wherein the heating time to heat said mold is about 20 to 30 minutes.

5. The manufacturing method of carbon fiber rackets as claimed in claim 4, wherein said blowing bag is made of high temperature resistant materials such as nylon or cellophane.
